(19) United States
(12) Patent Application Publication
(10) Pub. No.: US 2026/0061663 A1
(43) Pub. Date: Mar. 5, 2026

(54) METHOD AND CONNECTOR STRUCTURE FOR CONCRETE PRODUCT MOLDS

(71) Applicant: Columbia Machine, Inc., Vancouver, WA (US)

(72) Inventor: Denis Vishnevskiy, Vancouver, WA (US)

(21) Appl. No.: 18/825,863

(22) Filed: Sep. 5, 2024

(51) Int. Cl. B28B 7/24; B28B 7/34

(52) U.S. Cl. CPC B28B 7/241; B28B 7/346

(57) ABSTRACT

A mold assembly for forming concrete products comprises a plurality of partition plates spanning between pairs of end plates and forming one or more columns within a product mold matrix, where each of the partition plates have edge surfaces on each long end adjacent a respective one of the end plates and opposing faces along an expanse of the partition plate. A plurality of liners span between pairs of partition plates and form one or more rows within the product mold matrix, where each of the liners include edge surfaces on each long end adjacent a respective one of the partition plates, and buttons projecting from the edge surfaces of the liners configured to be received within complementary apertures formed through the faces of adjacent partition plates.

### BACKGROUND OF THE INVENTION

### 1. Field of the Invention

This invention relates generally to concrete products forming machines (CPMs) and more particularly to mold assemblies used in such machines using particular connection methods and features to assist in assembly of the mold.

### 2. Description of the Prior Art

Prior art machines for forming concrete products within a mold box include a product forming section comprising a stationary frame, an upper compression beam and a lower stripper beam. The mold assembly includes a head assembly that is mounted on the compression beam, and a mold box that is mounted on the frame and receives concrete material from a feed drawer. An example of such a system is shown in U.S. Pat. No. 5,807,591 which describes an improved concrete products forming machine (CPM) assigned in common to the assignee of the present application and herein incorporated by reference for all purposes.

The mold box and head assembly are matched together and configured to form concrete products in a specific shape, size, and number. Each product configuration requires a different mold. When the operator desires the CPM to produce products in different configurations, the mold assembly must be detached from mounts on the CPM and removed along with the assembly. A different mold box and head assembly must then be moved into place and mounted within the CPM.

Whereas some molds are provided with a fixed arrangement of mold cavities, making them useful for only a particular product type, some are modular so that plate assemblies within the mold box can be reconfigured to create a great variety of shapes, sizes, and a numbers of mold cavities that yield a great variety of molded concrete products. There are, however, challenges with manufacturing and assembling modular concrete product molds. Tight tolerances need to be applied to the wear components to achieve a tight fit and prevent significant tolerance stack up, which would lead to interferences with the concrete product machine mounting components. Further complicating the design, these wear parts need to be hardened through a heat treatment process, which results in warpage. This creates the need for any joint features to be machined from scratch or finished after heat treatment. The hard and brittle nature of the heat-treated material limits the machining processes that can be employed. Plate chipping/cracking, tool wear, and long machining times are major factors.

Prior methods for joining partition plates and liners within a mold box have several drawbacks. In one such method for joining plates within a mold box, dowel pins are used to join two perpendicular plates containing aligned holes. This method requires the liner to be thickened in order to accommodate a drilled hole on its edge surface. Thickening the liners results in larger spacing between them and a reduction in the number of liners that can fit inside the mold frame. This creates a disadvantage because the number of concrete products the mold produces per cycle is reduced.

Another such joining method includes tabs formed on the top and bottom of the liners that mate with a slot on the lower extremity of the partition plate and another slot near the top of the plate. This design includes several downsides including requiring that sharp corners to be cut into the hardened partition plates. Sharp corners under dynamic loading (e.g., mold vibration) create high stress regions that are prone to cracking. Machining options for sharp corners in hardened plates are also extremely limited, with the best option being wire electrical discharge machining (EDM), which is a significantly slower process compared to conventional machining methods, thus making this design less suitable for high-volume production or large parts. Finally, the tab and slot design provides only limited stress transfer contact surfaces when assembled, thus potentially reducing the stability of the joint and increased rocking during use.

Accordingly, there is need for an improved system and method for reducing the number of required components, simplifying manufacturing, and producing a stronger joint that minimizes these drawbacks.

### SUMMARY OF THE INVENTION

In a concrete product mold, hardened steel plates are joined together to create the product matrix. The Button Style Connection invention incorporates buttons machined into the male plate which fit into drilled/machined receiver holes on the female plate to achieve this secure, tight-fitting connection. This is a new way of joining hardened plates as well as connecting the hardened plates to the mold frame.

Applied to the connections between the liners and partition plates, this design replaces previous connection methods with buttons machined into the edge surface of the liners that fit tightly into receiver holes in the partition plates. These button positions on the liners are all aligned, but an alternative configuration where buttons are staggered/offset on two liners joined on either side of the partition plate would allow for an even thinner plate since button interference would not be a concern. This again has the potential to increase the quantity of products that the mold can produce.

The invention describes a mold assembly for forming concrete products comprises a plurality of partition plates spanning between pairs of end plates and forming one or more columns within a product mold matrix, where each of the partition plates have edge surfaces on each long end adjacent a respective one of the end plates and opposing faces along an expanse of the partition plate. Buttons are optionally machined or otherwise formed to project from the edge surfaces of the partition plates and configured to be received within complementary apertures formed in the adjacent end plate. A plurality of liners span between pairs of partition plates and form one or more rows within the product mold matrix, where each of the liners include edge surfaces on each long end adjacent a respective one of the partition plates, and buttons projecting from the edge surfaces of the liners configured to be received within complementary apertures formed through the faces of adjacent partition plates.

For mold assemblies having only a single row of molded product cavities, the mold assembly for forming concrete products comprises a first set of wear plates spanning between end plates and dividing the mold assembly into a plurality of mold cavity columns and one or more buttons extending from edge surfaces of the wear plates and configured to be received within apertures formed within the end plates so that the wear plates can be integrated into the mold assembly and define mold cavities therein.

In addition, a method for manufacturing wear plates within a mold assembly is described whereby, prior to heat treatment of the wear plates, buttons are machined on edge surfaces of a first set of wear plates. After heat treatment, apertures are formed through faces of a second set of wear plates and are configured to be arranged perpendicular to the first set within a mold assembly so that the apertures are aligned with the buttons of the first set of wear plates. The buttons are then further machined to within a prescribed diameter of the apertures.

Further, a method for manufacturing a mold assembly with an array of product mold cavities is described. The method of manufacture comprises arranging a plurality of partition plates within a mold assembly to create a plurality of spaced columns. The method further describes spanning a plurality of liners between adjacent partition plates within the spaced columns to create a plurality of spaced rows, the columns and rows defining the array of product mold cavities, whereby each of the liners include a plurality of buttons defined on edge surfaces thereof and adapted to mate within apertures aligned with the buttons and formed on faces of the partition plates. Assembly then proceeds whereby the buttons are received within the apertures to assembly the array of product mold cavities within the mold assembly.

Additionally, the invention describes a wear plate for use in a mold assembly of a type used for concrete molded products. The wear plate comprises a rigid plate having opposing faces defining a thickness of the wear plate therebetween and opposing edge surfaces on each end of the rigid plate spanning between the faces. One or more buttons are formed from the rigid plate and extend from each of the edge surfaces. The buttons have a width approximately equal to the wear plate thickness and are configured to be received within apertures formed within the mold assembly so that the wear plate can be integrated into the mold assembly and define mold cavities therein.

Applied to the connections between the partition plates and the end plates, this design replaces a wide range of connection methods with a new, simple, cost effective, and reliable solution and improves upon previous methods by reducing the number of required components, simplifying manufacturing, and producing a stronger joint.

The described button design has additional advantages by being more resistant to cracking than features (e.g. tab and slot) with right angles. Furthermore, the button design can be offset for full extension into partition plate. The partition plates can thus be made thinner, and this reduces rocking as with tab and slot design. Finally, further advantages versus the slot design include: (1) no sharp surfaces, (2) more methods of manufacture can be employed, thus improving manufacturing speed, and (3) improved joint strength by offering multiple support surfaces.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view of a mold box constructed according to teachings of the invention for use with a concrete products forming machine (CPM).

FIG. 2 is a partial exploded perspective view of a portion of the mold box of FIG. 1.

FIG. 3 is a magnified perspective view of a portion of FIG. 2.

FIG. 4 is a section side elevation illustrating joined plates and liners in the mold box of FIG. 1 according to a first embodiment of the invention.

FIG. 5 is a section side elevation illustrating joined plates and liners in the mold box of FIG. 1 according to an alternate embodiment of the invention.

### DETAILED DESCRIPTION

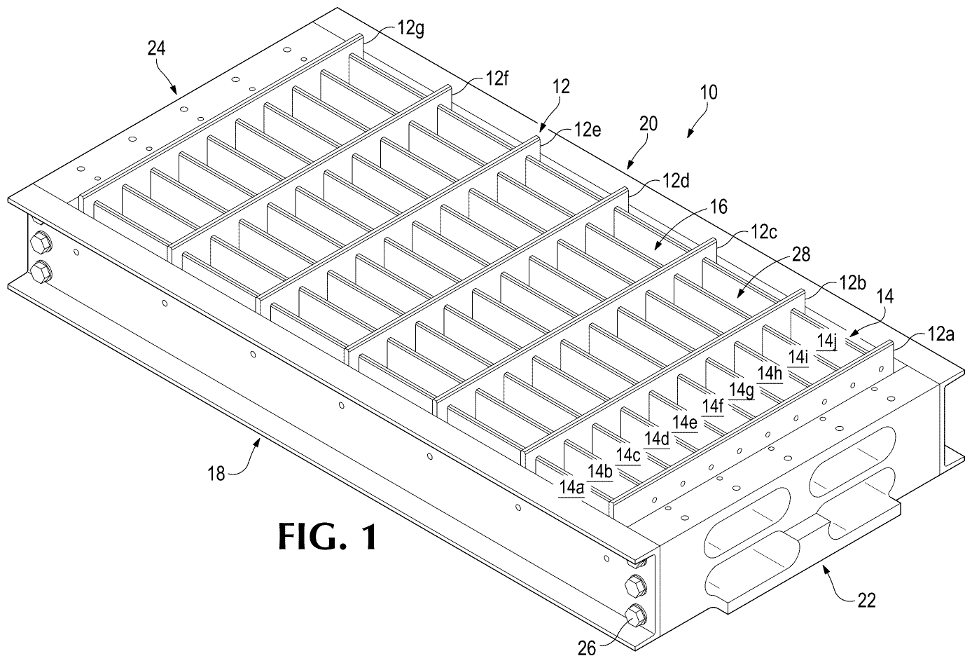

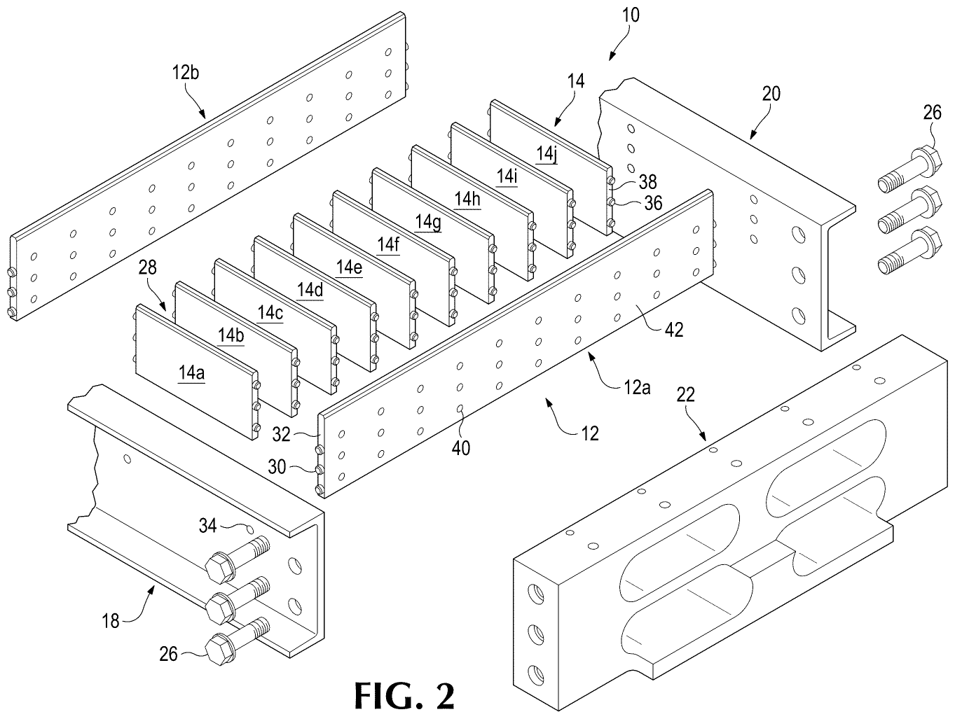

FIG. 1 shows an exemplary modular mold assembly 10 configured according to teachings of the present invention and having a plurality of wear plates, here partition plates 12 coupled to a series of liners 14, to form a product matrix 16 having a desired mold cavity configuration. The inventive method for coupling the partition plates 12 and liners 14 together are described in more detail further below with reference to FIGS. 2-5. The outer frame of the mold assembly 10 is constructed by coupling end plates 18, 20 with mounting brackets 22, 24 as by bolts 26 to define a rectangular expanse of the product matrix 16. The end plates 18, 20 support the partition plates 12 and liners 14 by methods described further below. The mounting brackets 22, 24 assist in mounting the mold assembly 10 to the concrete products forming machine (not shown) by known methods not relevant to the invention.

In the example shown in FIG. 1, the product matrix 16 includes a set of seven partition plates 12a-12g defining the columns of mold cavities 28 within the product matrix 16, and six sets of ten liners, for instance liners 14a-14j coupled between partition plates 12a and 12b. This configuration of partition plates 12 and liners 14 results in a product matrix 16 having a total of fifty-four rectangular mold cavities 28 arranged in six columns and nine rows.

FIG. 2 illustrates a first column of cavities 28 of the mold assembly 10 of FIG. 1 formed by the coupling of partition plates 12a and 12b with orthogonally disposed liners 14a-14j. The partition plates 12a and 12b are coupled between and supported by end plates 18, 20. A plurality of projections or buttons 30 are machined or otherwise integrally formed on the edge surface 32 of each end of the partition plates 12a, 12b and are received within apertures (e.g. end plate receiver 34) formed within or through an adjacent end plate (e.g. end plate 18). Likewise, orthogonally disposed liners (e.g. liner 14j) include a plurality of projections or buttons 36 that are machined or otherwise integrally formed on the edge surface 38 of each end of the liners 14 and mate with apertures or receivers 40 formed through the face of each partition plate (e.g., face 42 on partition plate 12a). Whereas the partition plates (e.g. partition plate 12a) span between the end plates 18, 20 to define one dimension of the product matrix, the liners 14 spans between a pair or partition plates (e.g. liner 14a spanning between partition plates 12a and 12b) to define a width of each product matrix column. The buttons 30 preferably span across approximately the full width of the edge surface 32 of the partition plate thickness as well as the edge surface 38 of the liner to provide maximal structure, support, and contact surface with the apertures (34 and 40, respectively) into which the buttons (30 and 36, respectively) are received.

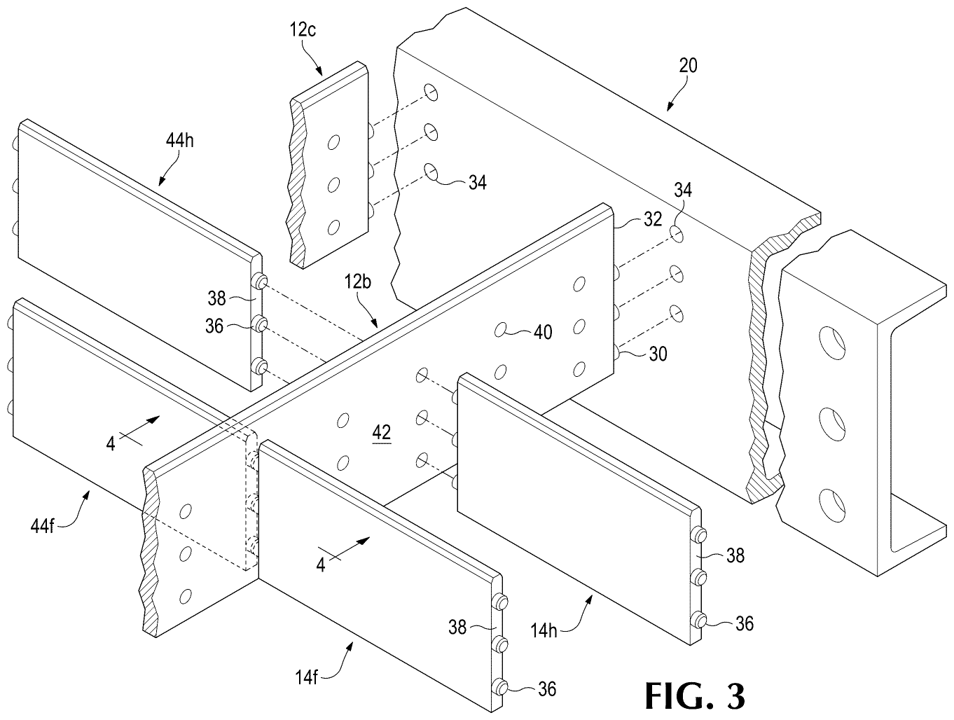

FIG. 3 shows a magnified view of a portion of the mold assembly 10 shown in FIG. 2, where partition plate 12b separates a first column of mold cavities from a second column. Of the full set of partition plates 12 and liners 14 forming the product matrix 16 for the mold assembly 10, only a subset of the liners and partition plates are shown in FIG. 3: here liners 14f and 14h on one side of partition plate 12b, and another set of liners 44f and 44h aligned with the first set 14f and 14 on the other side of partition plate 12b. A set of three buttons 30 are machined on the edge surface 32 of each liner 12b and are received within the three respective apertures 34 formed on the end plate 20. The embodiment shown also include three buttons 36 formed on each edge surface 38 of the liner 14h (also 44h), where the buttons on opposed liners 14h and 44h are aligned with one another so that they are received within the same set of three apertures formed through the face 42 of partition plate 12b.

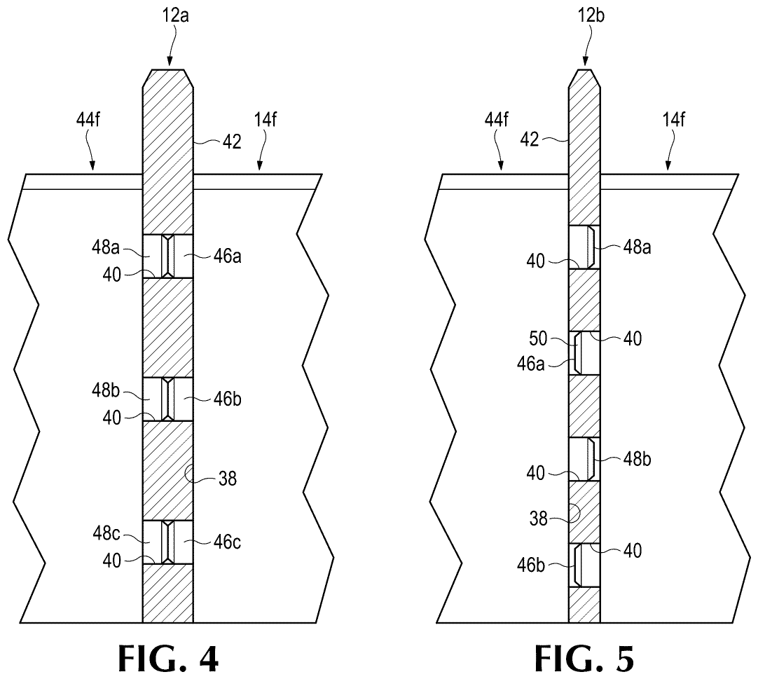

FIG. 4 shows a side section view of partition plate 12b where the buttons 46a, 46b, 46c formed on edge surface 38 of liner 14f are aligned with buttons 48a, 48b, 48c formed on the edge surface of liner 44f. Each of the aligned buttons are received in opposite ends of a respective aperture, for instance button 46a received within the right side of aperture 40 and button 48a received within the left side. The aperture 40 is defined fully through the partition plate 12b and the depth of the aperture would then need to be at least twice the length of the buttons so that the buttons can be fully seated within the aperture.

FIG. 5 shows a side section view of an alternate embodiment from FIG. 4 where the buttons on opposing plates are instead offset from one another so that they can be seated in completely different apertures. In this embodiment, and by way of example, two buttons 46a and 46b are formed on the edge surface 38 of liner 14f; and two buttons 48a and 48b are formed on the edge surface of liner 44f. A total of four apertures 40 are defined through the thickness of partition plate 12b, are spaced from one another along the height of the partition plate, and are aligned with the buttons on each of the side abutting liners. In this way, and although there are fewer buttons coupling the liners with the partition plates, the partition plate can be made thinner and thus take up less room within the product matrix 16, since the depth of the apertures 40 through it need only be matched to receive a single button. Each of the buttons preferably includes a chamfered edge 50 adapted to guide the button into the respective aperture during assembly.

### Design Specs

In many mold designs used in the invention, the thickness of the partition plates and liners are standard values like ⅜″, ½″, 10 mm, 12 mm, etc. Consequently, these dimensions match standard drill diameters. So, for maximum support, the buttons are preferably machined to a diameter nearly equal to the thickness of the plate. This means that the receiver holes can be drilled with a standard drill size that matches the thickness of the plate containing the buttons. Although, the button diameter is designed to be 0.001″ smaller than the diameter of the hole to prevent interference. For applications where plates exceed a certain thickness value, it would make sense for the buttons to be smaller than the thickness of the plate, but a higher number of buttons may be merited.

### Button Manufacturing

The buttons are manufactured on a CNC using an endmill. Prior to heat treat they are machined 0.015″ oversized in diameter. This allows them to be finished after the heat treatment process. This ensures that if there is any warpage in the plate, the buttons can be adjusted after heat treat such that their centers are within a +/−0.001″ of the prescribed positional dimension from the bottom of the plate and are within +0.000″/−0.002″ of the prescribed diameter. The edge of the button contains a 0.031*45-degree chamfer to guide the button into the receiver hole during assembly. Buttons should extend off the edge surface of the plate at least 50% of the thickness of the plate. For example, if a plate is 10 mm thick, the buttons should be at least 5 mm long. For best functionality, buttons shorter than 3/16″ are not recommended, and for longer/heavier plates, longer buttons should be used, up to 100% of the plate thickness.

Each connection should preferably have at least 2 buttons and holes. If the plate height allows, three or more buttons produce a more robust joint. The minimum distance from the center of a button to either the top or the bottom extremity of the plate should not be less than 1.5× the diameter of the button. Similarly, the center-to-center spacing between buttons should ideally not be less than twice the diameter of the button, with spacing of 2-4 times the diameter of the button preferred when possible for ease of manufacturing. However, the buttons may be defined on the edge surface closer together if the plate height is particularly small. The number of buttons per connection should be driven by plate height. A good rule of thumb is 1 button per every 2 inches of plate height, but they should be concentrated closer to the center of the plate, resulting in the best load distribution.

Other options exist including completing all the machining prior to heat treatment if it is observed that no significant warpage is caused. Along with that, tolerances can be increased slightly for ease of manufacturing, but this would need to be confirmed by testing. The chamfer is also an optional feature.

### Hole Manufacturing

If the receiver plate (the plate containing the holes) needs to undergo heat treatment, the holes are preferably to be drilled after heat treatment since any warpage will shift the hole positions. In the case that the button connection is used between one of the wear plates (liner or partition plate) and a non-hardened frame component like the end plate, the holes can be formed to be slightly elongated left to right to allow for some adjustment when installing the wear components into the frame. These elongated holes (or slots) are preferably to be created using a mill rather than a drill. Hole or slot diameter is preferably 0.001″ larger than that of the button with a diameter tolerance of +0.002/−0.000. The positional tolerance in both directions is preferably +/−0.001″. Other options exist including completing all the hole drilling prior to heat treatment if it is observed that no significant warpage is caused. It is possible, however, that tolerances can be increased slightly for ease of manufacturing.

### Alternative Designs (Offset Button Design)

For applications in which the hardened steel receiver plate thickness is ⅜″ or less and button joinery is required from both sides of the plate, offset rather than aligned buttons should be used. Some considerations are required though. Plate height should be taken into account to determine the allowable number of buttons per plate and the spacing between them. With offset buttons, the number of required holes in the receiver plate doubles. To maintain its integrity, the minimum distance between holes should be at least equal to the diameter of the holes. Even for plates thicker than ⅜″ offset and longer buttons may be advantageous for heavier components.

Having described and illustrated the principles of the invention in a preferred embodiment thereof, it should be apparent that the invention can be modified in arrangement and detail without departing from such principles. For instance, although round button and hole shapes are most advantageous for ease of manufacturing, alternative shapes would work as well. Elongated/elliptical buttons, square buttons with rounded corners, or various other shapes may work as well, but would be more costly to manufacture. Furthermore, it may be possible to use a single elongated or non-round button rather than a plurality of such on a single edge surface that mates into a complementary aperture to eliminate the potential for twisting as would be the case if a single round button were used. Additionally, the mold assembly can be configured with only a single set of wear plates (e.g., partition plates) to define multiple columns of mold cavities spanning between end plates, but that no orthogonally disposed wear plates (e.g. liners) are integrated into the mold assembly to define rows, so that only larger molded concrete blocks are formed. Accordingly, we claim all modifications and variation coming within the spirit and scope of the following claims.

What is claimed is:

1. A mold assembly for forming concrete products comprising:
a plurality of partition plates spanning between a pair of end plates and forming one or more columns within a product mold matrix, each of the partition plates having edge surfaces on each long end adjacent a respective one of the end plates and opposing faces along an expanse of the partition plate;
a plurality of liners spanning between a pair of adjacent partition plates and forming one or more rows within the product mold matrix, each of the liners having edge surfaces on each long end adjacent a respective one of the partition plates; and
buttons projecting from the edge surfaces of the liners configured to be received within complementary apertures formed through the faces of adjacent partition plates.

2. The mold assembly of claim 1, further including buttons projecting from the edge surfaces of the partition plates and configured to be received within complementary apertures formed in the adjacent end plates.

3. The mold assembly of claim 1, further including three or more buttons projecting from each of the edge surfaces of each of the partition plates.

4. The mold assembly of claim 1, wherein the buttons are configured with a round profile and adapted to be received within apertures having a round profile.

5. The mold assembly of claim 4, wherein the buttons are machined to have a slightly smaller diameter that a diameter of the aperture into which the buttons are received.

6. The mold assembly of claim 1, wherein the product mold matrix includes two or more columns and two or more rows and the apertures formed through faces of the partition plates couple between the faces of the partition plates, and wherein buttons on the edge surface of a liner in one column are received in opposite ends of the same apertures as buttons on the edge surface of a liner in an adjacent column so that the buttons face each other within the apertures.

7. The mold assembly of claim 1, wherein the product mold matrix includes two or more columns and two or more rows and the buttons formed on edge surfaces of liners within the same row of the product mold matrix are offset to one another so that buttons on one liner can extend within a first set of apertures on a face of the partition plate and buttons on a second liner within the same row extends within a second set of apertures, parallel with the first set, so that the buttons are not co-axial with one another.

8. The mold assembly of claim 1, wherein a center of each of the buttons is spaced at least 1.5× the diameter of the buttons from a top and bottom of the edge surface of the partition plate.

9. The mold assembly of claim 1, wherein a center-to-center spacing between adjacent buttons formed on the edge surface of the partition plate is not less than twice a diameter of the buttons.

10. The mold assembly of claim 9, wherein the center-to-center spacing between adjacent buttons is between about 2-4 times the diameter of the buttons.

11. The mold assembly of claim 1, wherein the buttons of the liner extend of the edge surfaces at least 50% of a thickness of the liner.

12. The mold assembly of claim 1, wherein each of the buttons includes a chamfered edge adapted to guide the button into the respective aperture during assembly.

13. A method for manufacturing wear plates within a mold assembly, comprising the steps of:
prior to heat treatment of the wear plates, machining buttons on edge surfaces of a first set of wear plates;
after heat treatment, forming apertures through faces of a second set of wear plates that are configured to be arranged perpendicular to the first set within a mold assembly so that the apertures are aligned with the buttons of the first set of wear plates; and
further machining the buttons to within a prescribed diameter of the apertures.

14. The method of claim 13, wherein the step of machining the buttons including machining the buttons to a diameter that exceeds a diameter of the apertures.

15. The method of claim 13, wherein the step of machining the buttons includes machining three or more buttons on the edge surfaces of each of the first set of wear plates.

16. The method of claim 15, wherein the step of machining the buttons includes machining the buttons to a length at least 50% a thickness of the second set of wear plates.

17. A wear plate for use in a mold assembly of a type used for concrete molded products, the wear plate comprising:
a rigid plate having opposing faces defining a thickness of the wear plate therebetween and opposing edge surfaces on each end of the rigid plate spanning between the faces; and
one or more buttons formed from the rigid plate and extending from each of the edge surfaces, the buttons having a width approximately equal to the wear plate thickness, with the buttons being configured to be received within apertures formed within the mold assembly so that the wear plate can be integrated into the mold assembly and define mold cavities therein.

18. The wear plate of claim 17, further including three or more buttons projecting from each of the edge surfaces of the wear plate.

19. The wear plate of claim 17, wherein the buttons are configured with a round profile and adapted to be received within apertures having a round profile.

20. The wear plate of claim 19, wherein a center of each the buttons is spaced at least 1.5× the diameter of the buttons from a top and bottom of the edge surface of the wear plate.

21. A mold assembly for forming concrete products comprising:
a first set of wear plates spanning between end plates and dividing the mold assembly into a plurality of mold cavity columns; and
one or more buttons extending from edge surfaces of the wear plates and configured to be received within apertures formed within the end plates so that the wear plates can be integrated into the mold assembly and define mold cavities therein.

22. The mold assembly of claim 21, further including three or more buttons projecting from each of the edge surfaces of the wear plate.

23. The mold assembly of claim 21, wherein the buttons are configured with a round profile and adapted to be received within apertures having a round profile.

24. The mold assembly of claim 23, wherein a center of each the buttons is spaced at least 1.5× the diameter of the buttons from a top and bottom of the edge surface of the wear plate.
